(19) United States
(12) Patent Application Publication
(10) Pub. No.: US 2020/0020054 A1
(43) Pub. Date: Jan. 16, 2020

(54) REAL ESTATE SYSTEM

(71) Applicant: Jeffrey Dale GLOVER, South Lyon, MI (US)

(72) Inventor: Jeffrey Dale GLOVER, South Lyon, MI (US)

(21) Appl. No.: 16/507,647

(22) Filed: Jul. 10, 2019

Related U.S. Application Data
(60) Provisional application No. 62/734,547, filed on Sep. 21, 2018.
(60) Provisional application No. 62/696,130, filed on Jul. 10, 2018.

(51) Int. Cl. G06Q 50/16; G06Q 30/02; G06Q 30/06

(52) U.S. Cl. CPC G06Q 50/16; G06Q 30/0623; G06Q 30/0283

(57) ABSTRACT

A real estate system for presenting a user interface and receiving user input relating to a residence may include a memory, and a controller coupled to the memory and configured to present selectable room specific attributes for each of a plurality of rooms, receive at least one customized attribute for at least one of the rooms, the at least one customized attribute selected from the selectable room specific attributes; and generate a residence value based on the at least one customized attribute.

### CROSS-REFERENCE TO RELATED APPLICATIONS

This application claims the benefit of U.S. Provisional Application Ser. No. 62/734,547 filed Sep. 21, 2018 and U.S. Provisional Application Ser. No. 62/696,130 filed Jul. 10, 2018, the disclosures of which are hereby incorporated in their entirety by reference herein.

### TECHNICAL FIELD

Disclosed herein are real estate systems, specifically systems with respect to the valuation of real estate properties via a mobile application.

### BACKGROUND

Real estate is a market that greatly fluctuates with multiple factors. Achieving an accurate estimate of a property may be key to properly marketing, leveraging, and/or maintaining that property. However, current systems fail to take into account many relevant factors when evaluating the value of a property.

### SUMMARY

A real estate system for presenting a user interface and receiving user input relating to a residence may include a memory, and a controller coupled to the memory and configured to present selectable room specific attributes for each of a plurality of rooms, receive at least one customized attribute for at least one of the rooms, the at least one customized attribute selected from the selectable room specific attributes; and generate a residence value based on the at least one customized attribute.

A method for generating a value for real property based on received user input relating to a residence may include presenting selectable room specific attributes for each of a plurality of rooms, receiving at least one customized attribute for at least one of the rooms, the at least one customized attribute selected from the selectable room specific attributes, and generating a residence value based on the at least one customized attribute.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompanying drawings in which:

FIG. 1 illustrates an example real estate system;

FIGS. 2A-2P illustrate example screens of a real estate application disclosed herein, where:

FIG. 2A illustrates an example splash screen;

FIG. 2B illustrates an example address screen;

FIG. 2C illustrates an example good home value screen;

FIG. 2D illustrates an example renovations screen;

FIG. 2E illustrates an example kitchen renovations screen;

FIG. 2F illustrates an example bathroom renovation screen;

FIG. 2G illustrates an example better home value screen;

FIG. 2H illustrates an example property detail screen;

FIG. 2I illustrates an example bedroom photo screen;

FIG. 2J illustrates an example camera screen;

FIG. 2K illustrates an example bedroom upload screen;

FIG. 2L illustrates an example photo review screen;

FIG. 2M illustrates an example collective photo screen;

FIG. 2N illustrates an example room specific photo screen;

FIG. 2O illustrates an example contact information screen;

FIG. 2P illustrates an example thank you screen;

FIG. 3 illustrates an example appraisal form;

FIGS. 4A-4D illustrate example screens of the real estate application relating to the taking of room measurements to generate the appraisal form of FIG. 3, where:

FIG. 4A illustrates an example measurement screen;

FIG. 4B illustrates an example measurement screen;

FIG. 4C illustrates an example dimension screen;

FIG. 4D illustrates an example dimension summary screen; and

FIG. 5 illustrates an example process of the real estate system for presenting a sequence of screens to iteratively guide the user through the valuation process described herein.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

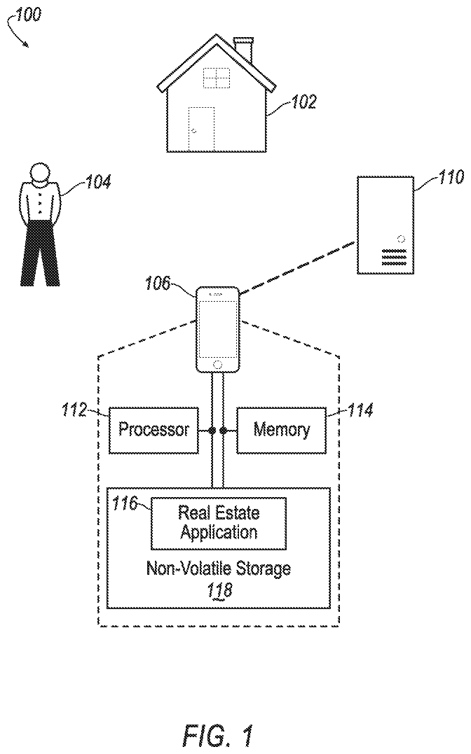

FIG. 1 illustrates an example real estate system 100 for evaluating various properties. The system 100 may relate to the valuation of a property 102 such as a home, parcel of land, etc. The property 102 may be a house, apartment, condominium, garage, storage shed, land, multi and single dwelling residence, etc. The property 102 may be a property associated with a user 104 for which the user 104 may wish to acquire a property value therefor. For example, if the user is applying for a mortgage on the property 102 or about to put the property 102 up for sale, the user 104 may desire an accurate valuation for the home.

A mobile device 106 may be associated with the user 104. The mobile device 106 may be any form of computing device capable of receiving user input and performing the processing operations described herein, such a smart phone, tablet computer, personal digital assistant, smartwatch, MP3 device, laptop computer, etc. The mobile device 106 may include a processor 112 including a controller, and a memory 114. The controller may be generally coupled to memory 114 via the processor 112 for operation of instructions to execute equations and methods described herein. In general, the controller is programmed to execute the various methods as noted herein. For example, the controller may generate a sequence of screens to iteratively guide the user 104 through the valuation process described herein.

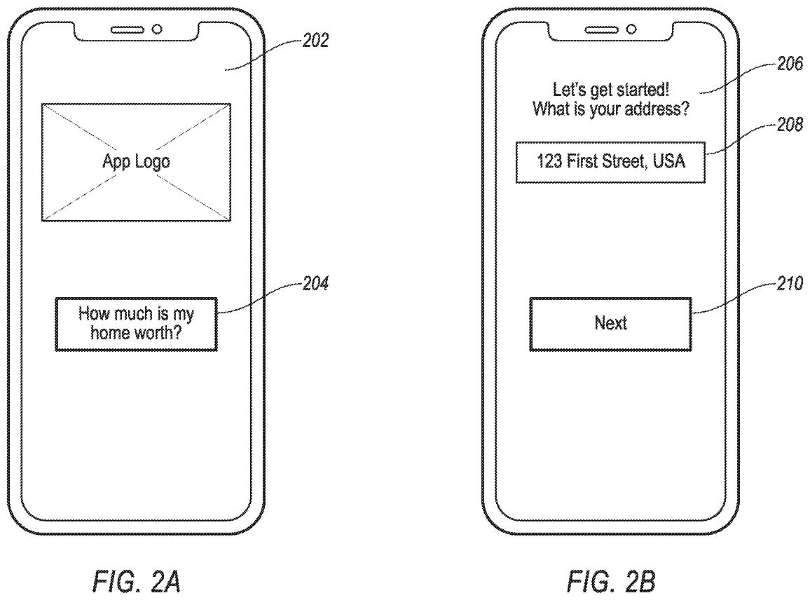

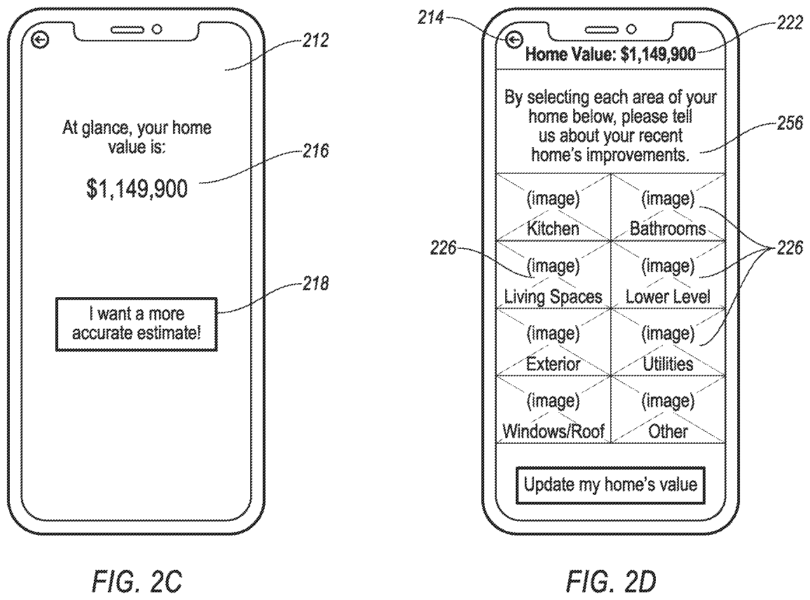

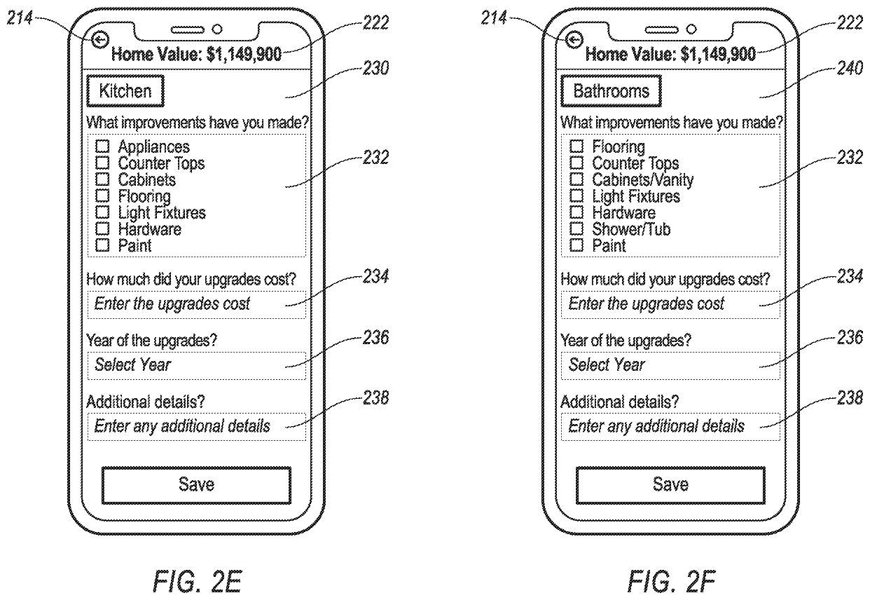

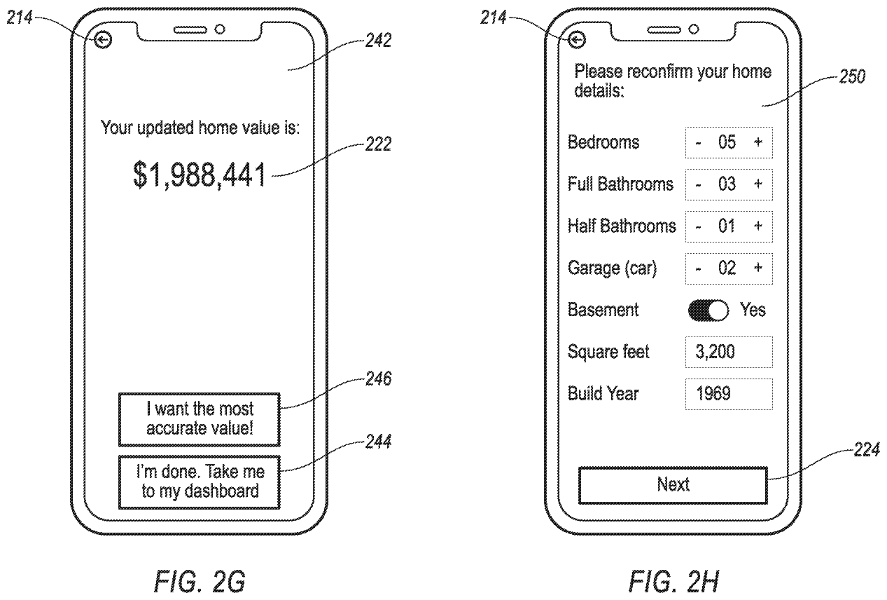

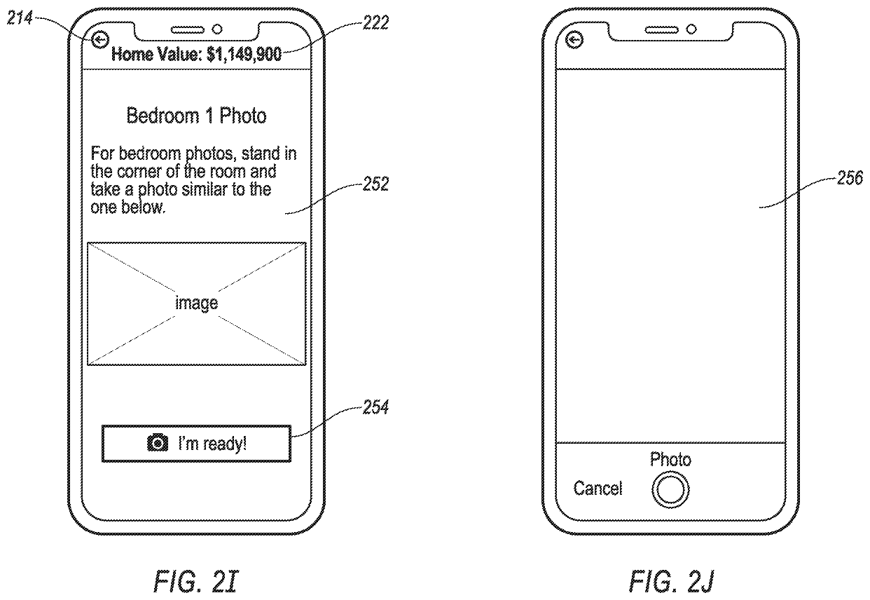

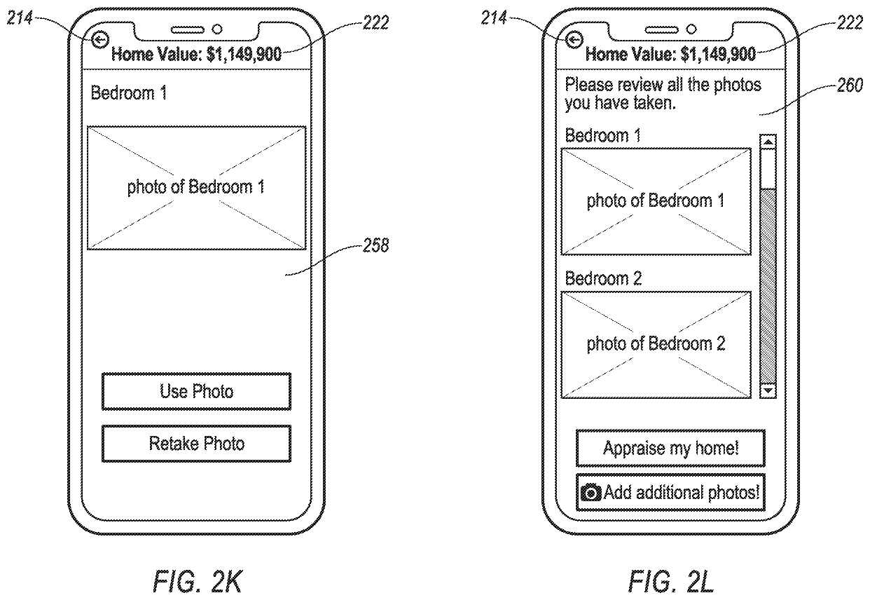

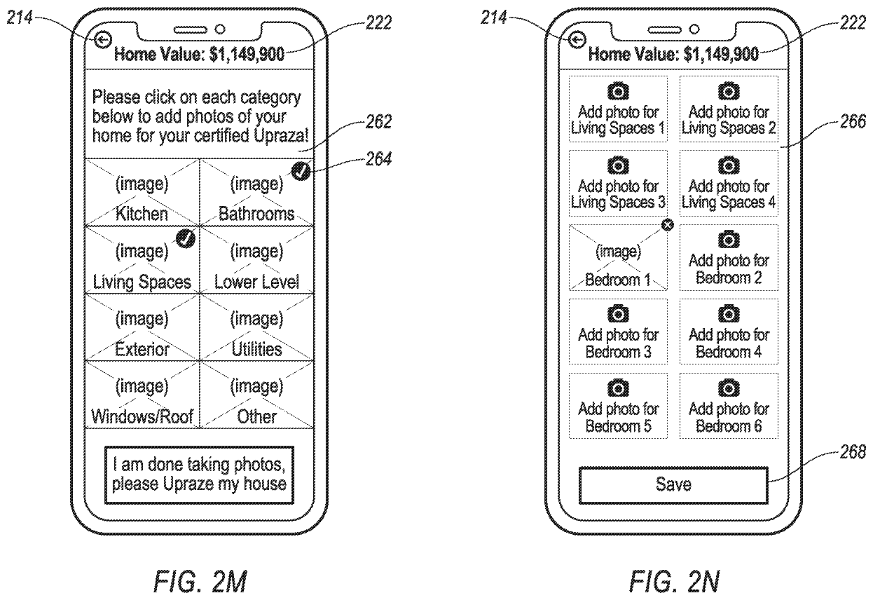

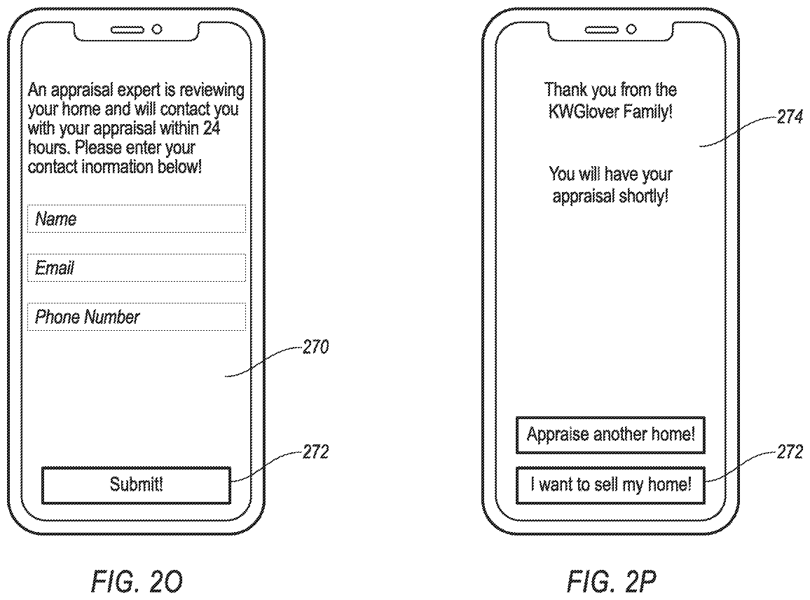

The mobile device 106 may include a display configured to display various screens to the user 104. The mobile device 106 may include a real estate application 116 configured to run on a controller of the mobile device 106. For instance, the mobile device 106 may include a non-volatile storage 118 onto with the real estate application 116 is stored. The real estate application 116 is described in more detail below with respect to the screen shots of FIGS. 2A-D.

The server 110 may be a networked computing device, such as a cloud server, configured to store and maintain data as well as act as a gateway to other mobile devices (not shown) and other users.

When executed by the mobile device 106, the real estate application 116 may be programmed to receive input from a user regarding the property 102 and provide a home valuation for the user in response to the input and external factors. The application 116 may guide the user 104 through the process of taking photos of various rooms of the home, and may provide important information to the user in order to acquire the most accurate information and highest quality photos possible. For example, the real estate application 116 may present the user 104 with room-specific screens. These screens may present various selectable room attributes to the user. For example, if the room is a kitchen, the user may be able to select features that are specific to a kitchen, such as countertops, cabinets, etc. These selectable attributes are described in more detail below. The user 104 may input or select the attributes that correspond to the property that the user wishes to value. The screens may be sequentially presented. Upon completion of one room, a screen relating to another room may be presented. This allows the real estate application 116 to guide the user through the process to achieve a more accurate property estimate.

The application 116 may also guide the user through the taking of room measurements to fill in further details of an appraisal form. This combined set of information will then allow the user to request and acquire a valuation of the property 104.

FIGS. 2A-P illustrate example screens provided to the user 104 via the mobile device 106. These screens are exemplary and may vary from these illustrative examples.

FIG. 2A illustrates an example splash screen 202. The splash screen may present a user selectable “how much is my house worth” button 204. A selection of the button may present an address screen 206.

FIG. 2B illustrates an example address screen 206. The address screen may present an address entry field 208. This field may be pre-populated with a geolocation of the mobile device 106. This may be especially helpful when the user 104 is a Realtor® that deals with multiple properties and is not as familiar with the street addresses of the particular property 102. This field may default to include the geolocation, but may be editable. Additionally or alternatively, the user 104 may enter the address and the application may use Google Maps™ to locate the address. The “next” button 210 may present a home value screen 212.

FIG. 2C illustrates an example good home value screen 212. This screen may present a back button 214 configured to return the user to the address screen 206. The home value screen 212 may also present an “at a glance” home value 216. This estimate may be presented based on data from a third party such as Zillow™, Redfin™, Home Junction/Smart Zip Data, or other estimation system based on the user entered address. An “I want a more accurate estimate” button 218 may present a renovations screen 220.

FIG. 2D illustrates an example renovations screen 220. This screen may prompt the user 104 with the option to add improvements that have been done to the property 102. For example, the user may select one of various rooms/property attributes buttons 226. These buttons 226 may allow for selections of certain room specific attributes that could affect the property estimate. The attributes may include items that may be upgraded or renovated. The attributes may include aesthetic features, such as paint, finishes, flooring, etc. The attributes may include countertops, hardware, appliances, etc. The attributes shown throughout the screenshots are exemplary, and it should be noted that any number of attributes or property details that affect a home's value may be used. The attributes may be room specific. That is, the user may not need to select “countertops” for a bedroom, but may be able to do so for a bathroom or kitchen. By applying room-specific attributes, the user is not bogged down with undue detail or intensive data entry with respect to the property being valued.

The home's value amount 222 on the top right corner may be the value acquired from one or more of the above external source(s) as. The user 104 may select zero, one, or more of the room/attribute buttons 226. If the user has not selected any of the room/attribute buttons 226, selection of the “next” button 224 may present a better home value screen as illustrated in FIG. 2G. If the user has selected one of the room/attribute buttons 226, the selection of the “next” button may present a screen associated with one of the selected buttons, such as a kitchen renovations screen. Notably, the user 104 may select or “highlight” any number of these buttons by tapping or clicking on the respective button 226. Tapping again on a selected button may toggle off or deselect that button. When the user selects “next” and multiple buttons have been selected, a screen associated with each of the selected buttons will be presented to the user. The selected buttons may alter in appearance once selected or deselected. For example, the buttons may become faded, change size, etc., upon selection.

Notably, each of the rooms that is selected may generate an additional renovation screen in the guided workflow of the real estate application 116 that is customizable to that room. For example, if the basement is selected as one of the rooms, a “basement” renovation screen may be provided that includes options for the types of renovations that a “bedroom” renovation screen may not include, and vice versa. This provides a convenient way to remind the user of various upgrades that he or she may have made to the home in specific rooms. Each renovation screen may also request photos specific to that room. For example, the basement renovation screen may prompt for photos of the furnace, while a kitchen renovation screen may not. As explained, these attribute buttons 226 may correspond to rooms, or other property type of attributes such as utilities, including furnace, air conditioning, water softeners, water tanks, etc. These buttons 226 may also include exterior updates, windows and roof updates, etc. The back button 214 may return the user to the good home value screen 212.

FIG. 2E illustrates an example kitchen renovations screen 230. This screen 230 may prompt the user 104 to enter and/or select various attributes relating to the property's kitchen. Specific attributes, upgrades, and materials may be presented for user selection, such as which improvements were made in an improvements block 232. The specific cost of the renovation, as well as the timing of the same may also be entered at blocks 234 and 236, respectively. The user 104 may enter additional details in block 238. This may be a location for the user to include additional features, such as “kitchen includes counter depth refrigerator,” etc. The attributes entered and selected on this kitchen screen 230 may be used by the application 116 to more accurately evaluate the property. Thus, the attributes may include selectable features as well as fillable blocks. Such user customized attributes allow for a better estimate.

If multiple room buttons were selected in renovations screen 220, then the next renovation screen, such as a bathroom renovation screen, will be presented. If only the kitchen button was selected, then the real estate application 116 may guide the user 104 to the better home value screen as illustrated in FIG. 2G. By sequentially presenting the renovation screens, the user may be easily guided through the process of entering information for the property. The iterative and sequential approach pulls information that may have otherwise been overlooks, or worse, not even considered, in evaluating property.

FIG. 2F illustrates an example bathroom renovation screen 240. This screen 240 may prompt the user 104 to and/or select various attributes relating to the property's bathroom renovation. Specific finishing and attributes specific to a bathroom, such as the shower, tub, etc., may be presented for customization by the user 104 in the improvements block 232. The specific cost of the renovation, as well as the timing of the renovations may also be entered at blocks 234 and 236, respectively. The user 104 may enter additional details in block 238, similar to the kitchen renovation screen 230. As the user 104 completes these renovation pages, the home or residence value in the top right of the example screens will update. Selecting the “next” button may present the next renovation screen or the better home value screen if no more room buttons were selected.

FIG. 2G illustrates an example better home value screen 242. This screen 242 may present the updated home value 222 based on the user-entered data in the renovation screens. The updated home value 222 may iteratively update as information is input via the application 116. That is, as attributes are added and customized by the user, the home value 222 may subsequently update. This user 104 may thus monitor the change in value and thus appreciate how customizing the attributes impacts the value. The user 104 may select a dashboard button 244 to proceed to a dashboard screen. The user 104 may also select a more accurate button 246 to proceed to a property detail screen 250. The numbers in these categories may default to those used by the third-party estimators such as Zillow™, but may be editable by the user 104.

FIG. 2H illustrates an example property detail screen 250. This screen 250 may allow the user 104 to input how many bedrooms and bathrooms the property 102 has, as well as other attributes such as square footage, year built, garage stalls, etc.

The “next” button 224 may present a photo screen (not shown) listing out a plurality of rooms to photograph. These rooms may be similar to the renovations screen 220 and may each be individually selected. Upon selection of one of the rooms/attributes 226 (as shown in FIG. 2D), a photo screen corresponding to the selected room may be presented. This screen is described in more detail with respect to FIG. 2M below.

FIG. 2I illustrates an example bedroom photo screen 252. The bedroom photo screen 252 may be presented for each of the number of bedrooms selected in FIG. 2H. The screen may provide instructions to the user to guide the user into taking a high-quality, highly informative, photo of the first bedroom. The “I'm ready button” 254 may open the phone's camera application and the user 104 to take a photo.

FIG. 2J illustrates an example camera screen 256. Selecting the round photo button may present a bedroom photo upload screen.

FIG. 2K illustrates an example bedroom upload screen 258. This screen may present the user 104 with the option to use or retake the photo. This process may be repeated for other rooms in the house such as the other bathrooms, kitchen, living room, garage, etc.

FIG. 2L illustrates an example photo review screen 260. This screen allows the user 104 to easily view all of the uploaded photos. Selection of the “appraise my home!” button may present a contact screen (discussed below with respect to FIG. 2O). Selection of the “add additional photos” button may present the camera screen 256.

FIG. 2M illustrates an example collective photo screen 262 similar to that presented in FIG. 2D. Selection of the individual rooms/attributes 226 may present photo screens corresponding to those rooms. Rooms that have photos associated with them through the processes described above, may present a check mark 264 thereon or other indication of completion. Such progress indicators may encourage the user to continue to update photos and information about the property as well as aid the user in remembering what rooms have been entered.

FIG. 2N illustrates an example room specific photo screen 266. This screen 266 help to further guide the user 104 through the photo-taking process. For example, specific photo icons are presented for each relevant room. Here, a bedroom photo is listed for each bedroom in the house. The number of bedrooms corresponds to the bedrooms entered in the property detail screen 250. As photos are uploaded or taken, a thumbnail of the photo may be included, as illustrated for “Bedroom 1”. This aids the user 104 in keeping track of the photos that have been uploaded, as well as provides a quick visual for the type of photos that have been taken. The user 104 may select the “save” button 268 to save the images and return to the collective photo screen 262. At this screen 262, a new check mark 264 may be included to update the user's progress.

FIG. 2O illustrates an example contact information screen 270. This screen may permit the user 104 to enter his or her contact information. Selecting the “submit” button 272 may present the user with a thank you screen.

FIG. 2P illustrates an example thank you screen 274. The user 104 may select to appraise their home or take to sell their home. Selecting the “I want to sell my home button” may leave the real estate application 116 and open up a web browser to present a specific real estate web site.

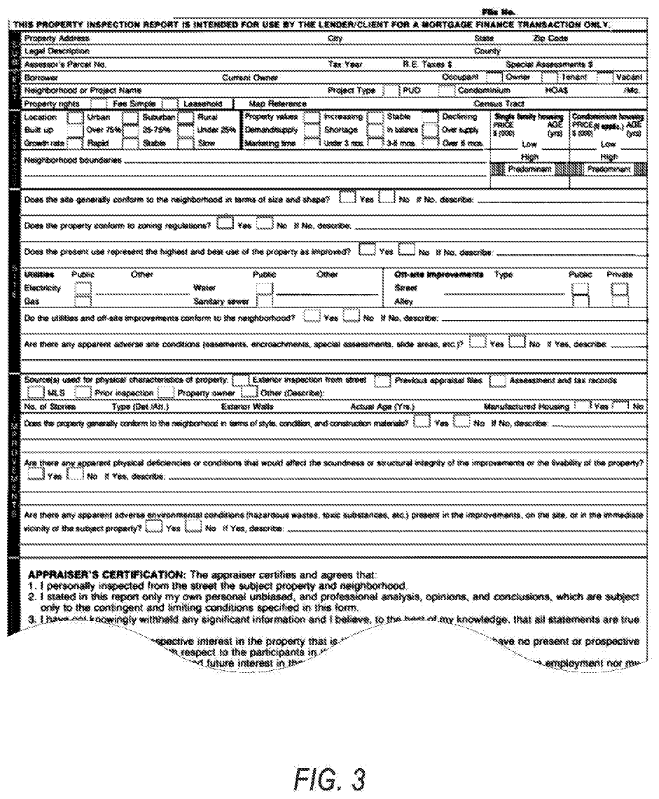

FIG. 3 illustrates an example appraisal form. In addition to providing real-time, accurate, and up to date home values, the real estate application 116 may also transcribe the inputted information in a report such as an appraisal form. The appraisal form, for additional consideration such as a fee, may be signed by an appraiser. The transcribed report may provide the appraiser with enough information, specifics, and high-quality photos that the need for an appraiser to physically visit the property 102 is eliminated.

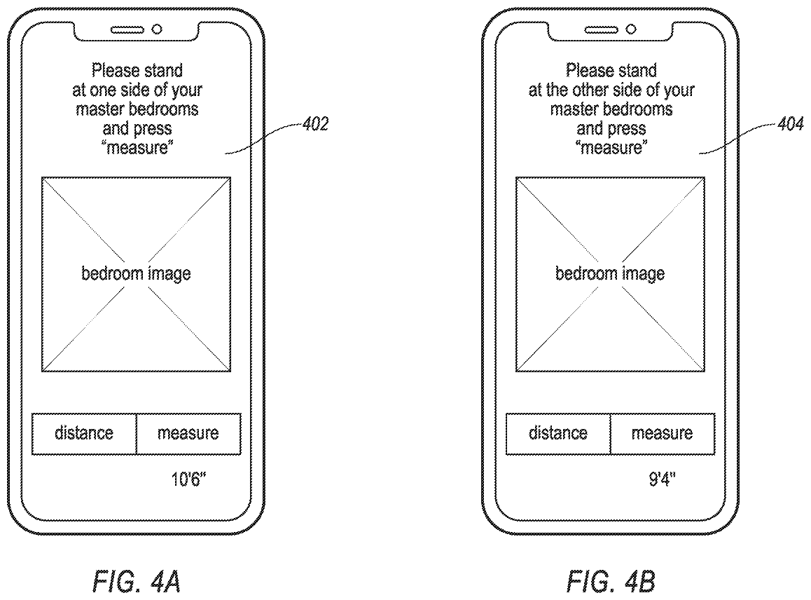

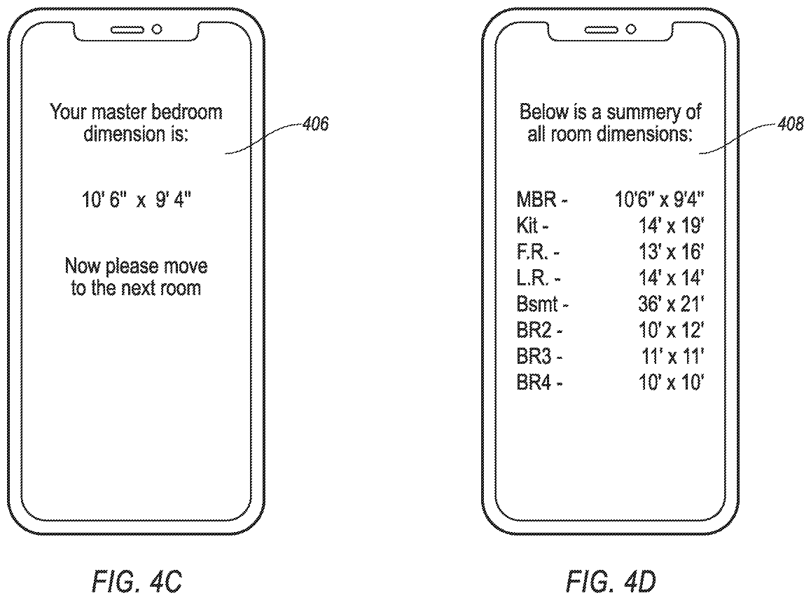

FIGS. 4A-4D illustrate example screens of the real estate application relating to the taking of room measurements to generate the appraisal form of FIG. 3. To aid in the collection of room measurements, the application 116 may instruct the user via the display screens to stand at various locations in the specific room.

FIG. 4A illustrates an example measurement screen 402 instructing the user to take a photo at one side of the master bedroom. Responsive to the user selecting a “measure” control, the application 116 uses the imaging capabilities of the phone to measure a dimension of the room (e.g., length of the room).

FIG. 4B illustrates an example measurement screen 404 instructing the user to take a photo at an opposite side of the master bedroom. Responsive to the user again selecting the “measure” control, the application 116 uses the imaging capabilities of the phone to measure another dimension of the room (e.g., width of the room).

FIG. 4C illustrates an example dimension screen 406 whereby the real estate application 116 may generate and display the room dimensions based on the photographs. For example, the images acquired from more than two locations within a room may be used to generate the estimated room dimensions. The user may then continue to any further rooms to be measured and may complete those measurements as discussed above. For instance, for each room the user may select which room he or she is currently measuring, as well as have the option to enter a custom room name.

FIG. 4D illustrates an example dimension summary screen 408 illustrating the various room dimensions for the home. While an example set of rooms is illustrated, more or fewer rooms may be included in the summary. These room measurements may then be translated into the appraisal form to further aid in providing the appraiser with complete information about the property 102.

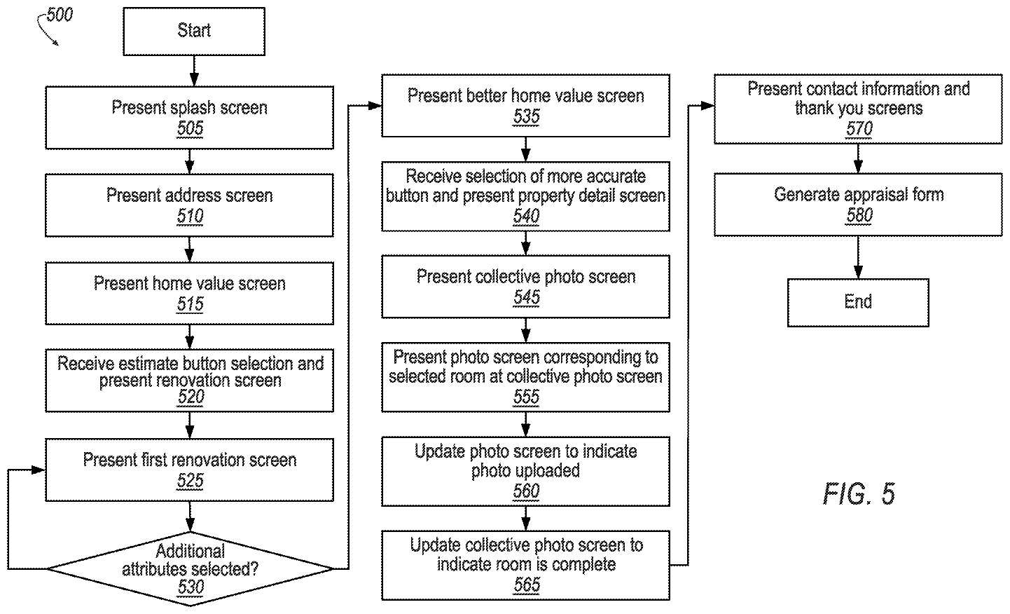

FIG. 5 illustrates an example process 500 of the real estate system 100 for presenting a sequence of screens to iteratively guide the user 104 through the valuation process described herein. The process 500 begins at block 505 where the processor presents the splash screen 202. At block 510 the processor presents the address screen. At block 515 the processor presents the home value screen 212.

At block 520, in response to receiving a selection of the estimate button 218, the processor presents the renovations screen 220. At block 525, the processor presents a first renovation screen, similar to the kitchen renovations screen 230. The renovation screen corresponds to one of the selected attribute buttons 226. Thus, instead of the user being presented with a fillable form for an entire property, the user is presented with sequential screens, each relating to a room. Then, each screen presents attributes customary to that room. This eliminates undue burden on the user and encourages the entry of information regarding the property. Once one room is complete, another screen related to another room may be presented, and so on.

At block 530, the processor determines whether additional attribute buttons 226 were selected. If so, the process 500 returns to block 525. If not, the process 500 proceeds to block 535.

At block 535, the processor presents the better home value screen 242. At block 540, the processor presents the property detail screen 250 in response to the selection of the more accurate button 246.

At block 550, the processor presents the collective photo screen 262. At block 555, the processor presents an example photo screen corresponding to a selected room at the collective photo screen 262.

At block 560, the processor updates the photo screen similar to the example bedroom upload screen 258. At block 565, the processor may update the collective photo screen 262 with an indication that the selected room is completed.

At block 570, the processor may present a contact information screen 270 and a thank you screen 274. At block 580, the processor may generate the appraisal form, similar to the example shown in FIG. 3, based on the user inputs. The processor may also generate the residence or property value. The process may then end.

Accordingly, the real estate system 100 allows users to enter room specific attributes. These room specific attributes may be presented via a user interface and may be specific to a room type. The room type may dictate the options and attributes presented to the user. Once the user has selected and customized the room, the customized attributes may be used to update an appraisal of the property. Additionally, the system 100 guides the user through the process of inputting information in an effort to encourage the user to make progress and receive a more accurate appraisal. Existing systems may rely on square footage and number of rooms, but fail to take into account specific attributes for each room that are often upgraded during renovations.

The system 100 may also guide the user and provide feedback for photo taking, among other inputs. These inputs may be used to generate an appraisal form.

Computing devices described herein generally include computer-executable instructions, where the instructions may be executable by one or more computing or hardware devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1. A real estate system for presenting a guided user interface and receiving user input relating to real property, comprising:
a memory; and
a controller coupled to the memory, configured to
present selectable room-specific attributes for each of a plurality of rooms of the real property;
receive at least one customized attribute for at least one of the rooms, the at least one customized attribute selected from the selectable room-specific attributes; and
generate a residence value based on the at least one customized attribute.

2. The system of claim 1, wherein the selectable room-specific attributes include a plurality of selectable renovated features.

3. The system of claim 1, wherein the selectable room-specific attributes include a fillable monetary value of a renovation.

4. The system of claim 1, wherein the selectable room-specific attributes include a selectable year of completion of a renovation.

5. The system of claim 1, wherein the controller is further configured to present a photo screen displaying a plurality of selectable rooms.

6. The system of claim 5, wherein the controller is further configured to present a room specific photo screen displaying at least one thumbnail identifying a specific image view in response to a selection of one of the selectable rooms.

7. The system of claim 6, wherein the controller is further configured to update the thumbnail with an image in response to a user selection of the image corresponding to the identified specific image view.

8. The system of claim 5, wherein the controller is further configured to identify at least one of the selectable rooms as complete in response to a photo being uploaded for the respective room.

9. The system of claim 1, wherein the controller is further configured to generate an appraisal form based at least in part on the customized attributes.

10. A method for generating a value for real property based on received user input relating to a residence, comprising:
presenting selectable room specific attributes for each of a plurality of rooms;
receiving at least one customized attribute for at least one of the rooms, the at least one customized attribute selected from the selectable room specific attributes; and
generating a residence value based on the at least one customized attribute.

11. The method of claim 10, wherein the selectable room specific attributes include a plurality of selectable renovated features.

12. The method of claim 10, wherein the selectable room specific attributes include a fillable monetary value of a renovation.

13. The method of claim 10, wherein the selectable room specific attributes include a selectable year of completion of a renovation.

14. The method of claim 10, further comprising presenting a photo screen displaying a plurality of selectable rooms.

15. The method of claim 14, further comprising presenting a room specific photo screen displaying at least one thumbnail identifying a specific image view.

16. The method of claim 15, further comprising updating the thumbnail with an image in response to a user selection of the image corresponding to the identified specific image view.

17. A real estate system for presenting a guided user interface and receiving user input relating to real property, comprising:
a memory; and
a controller coupled to the memory, configured to
receive selection of at least one of a plurality of rooms of the real property for which customized information is to be entered, each room being of a predefined room type,
display a user interface guiding user input through a sequence of screens where for each selected room, selectable room-specific attributes are presented that correspond to the respective room type of the room;
receive at least one customized attribute from the selectable attributes for each selected room; and
generate a real property value based on the at least one customized attribute.

18. The system of claim 17, wherein the room-specific attributes include at least one of a cost of upgrades and a year of completions for the upgrades.

19. The system of claim 17, wherein the selected room is a kitchen and the room-specific attributes include at least one of a countertop, cabinets, appliances or hardware.

20. The system of claim 17, wherein the selected room is a bathroom and the room-specific attributes include at least one of a countertop, vanity, shower, or hardware; and wherein the controller is further configured to present the room specific attributes associated with the bathroom in response to receiving the at least one customized attribute for the kitchen.
